(19) United States
(12) Patent Application Publication
(10) Pub. No.: US 2008/0086022 A1
(43) Pub. Date: Apr. 10, 2008

(54) Method for complex stabilization of Pb and As bearing waste and soils

(76) Inventor: Keith Edward Forrester, Meredith, NH (US)

Correspondence Address: Keith E. Forrester, 78 Tracy Way, Meredith, NH, 03253, US

(21) Appl. No.: 11/712,752

(22) Filed: Mar. 1, 2007

Related U.S. Application Data
(60) Provisional application No. 60/849,598, filed on Oct. 5, 2006.

(51) Int. Cl. A62D 3/00

(52) U.S. Cl. 588/256

(57) ABSTRACT

This invention provides a method for chemical stabilization of combined Pb and As bearing materials, contaminated soils and wastes subject to acid and water leaching tests or leach conditions by addition of stabilizing agents such that the leaching potential is inhibited to desired levels. The resultant material or waste after stabilization is deemed suitable for on-site reuse, off-site reuse or disposal as RCRA non-hazardous waste.

### BACKGROUND OF THE INVENTION

Over the past thirty years, the dangers of heavy metal bearing wastes and contaminated soils has been the subject of community pressure, public awareness and ever stricter regulatory control in order to reduce or eliminate the dangers to people directly and to the surrounding environment. The leaching of heavy metals into groundwater is a grave concern because of the danger that the drinking water supplies and the environment will become contaminated.

Heavy metal bearing wastes and contaminated soils may be deemed hazardous by the United States Environmental Protection Agency (U.S. EPA) pursuant to 40 C.F.R. Part 261 if containing heavy metals at leachable levels exceeding 100 times the drinking water standards. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the TCLP leaching procedure.

40 C.F.R., Part 261.24(a), contains a list of contaminants and their associated maximum allowable concentrations as solid waste. If a contaminant, such as lead and arsenic, exceeds its maximum allowable concentration, when tested using the Toxicity Characteristic Leaching Procedure (TCLP) analysis as specified at 40 C.F.R. Part 261 Appendix 2, then the subject waste is classified as TCLP hazardous. The TCLP test uses a dilute acetic acid either in de-ionized water (TCLP fluid 2) or in de-ionized water with a sodium hydroxide buffer (TCLP fluid 1). Both extracts attempt to simulate the leachate character from a decomposing trash landfill in which the hazardous waste being tested for is assumed to be disposed of in and thus subject to the acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for defined metals. The TCLP test is designed to simulate a worst-case leaching situation, that is leaching conditions that would typically be found in the interior of an actively degrading municipal landfill. Such landfills normally are slightly acidic with a pH of approximately 5±0.5. Countries outside of the US also use the TCLP test as a measure of leachability such as Thailand, Taiwan, Philippines, and Canada. Thailand also limits solubility of Cu and Zn, as these are metals of concern to Thailand groundwater. Switzerland and Japan regulate management of solid wastes by measuring heavy metals and salts as tested by a sequential leaching method using carbonated water simulating dilute acid rainwater.

Additionally, U.S. EPA land disposal restrictions prohibit the land disposal of solid wastes that leach in excess of maximum allowable concentrations upon performance of the TCLP analysis. The land disposal regulations require that hazardous wastes are treated until the heavy metals do not leach at Universal Treatment Standards (UTS) levels from the solid waste at levels above the maximum allowable concentrations prior to placement in a surface impoundment, waste pile, landfill or other land disposal unit as defined in 40 C.F.R. 260.10.

In addition to the regulatory concern of leaching potential of heavy metals from mixed solid waste disposed in solid waste landfills, the USEPA has published leaching tests which have been developed to predict the leaching potential of heavy metals from wastes and or materials that are not landfilled, but monofilled or reused in the environment without liner and leachate collection and management options. These published tests are often used to determine stabilized waste reuse suitability under remedial projects where large amounts of contaminated soils are stabilized and reused on-site as fill or base material, thus avoiding expensive transportation and disposal costs. The two most common tests used for in-place disposal leachate prediction are the Synthetic Precipitant Leaching Procedure (SPLP) USEPA Method 1310, and the Multiple Extraction Procedure (MEP) USEPA Method 1320. Although neither of these leach tests are promulgated as leach tests required under 40 CFR or CERCLA regulations, the tests are often required by regulators and compared to groundwater standards for remediation projects that dispose and/or reuse of stabilized wastes and contaminated soils on-site with either groundwater of surface water exposure potential.

Leach test conditions thus include the conditions to which a waste, material or contaminated soil is subjected during dilute acetic acid leaching (TCLP), buffered citric acid leaching (California STLC leach test), distilled water, synthetic rainwater or carbonated water leaching (SPLP, MEP, Japanese, Swiss, and SW-924).

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable acid rain leaching test includes the USEPA method 1312 Synthetic Precipitant Leaching Procedure (SPLP) which method is identical to the TCLP test with the replacement of the TCLP acetic acid with a SPLP dilute 40% nitric and 60% sulfuric acid solution at a extract solution pH level of 4.8 units for testing of wastes and soil East of the Mississippi River and a pH extract solution of 5.0 units West of the Mississippi River.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached selenium is then analyzed by Inductively-Coupled Plasma (ICP) after filtration of a 100 ml aliquot from the tumbler through a 45 micron glass bead filter.

Suitable multiple extraction test include the USEPA Method 1320, a sequential extraction of solid using the SPLP test method with adjustment of the extract pH to 3.0 units, and repeating the extraction on the solid phase sample ten (10) times with each sequential extract analyzed for the heavy metal of concern.

Of specific interest regarding the present invention is stabilization of both Pb and As from one contaminated soil under a combination of leach tests including rainwater leached unsaturated zone and brackish water and rainwater saturate groundwater, Method 1312 SPLP and Method 1320 MEP conditions, as well as non-landfill conditions such as open industrial sites, waste storage cells, waste piles, waste monofills, and under Method 1311 TCLP for determination of hazardousness of any given soil, material or waste.

The present invention provides a method of reducing the leachability of combined heavy metal bearing contaminated soil including the groups Pb and As under SPLP, TCLP, and MEP while using a single step application.

Unlike the present invention, prior art additives and mixtures have focused on reducing the leachability of single heavy metals such as Lead, Arsenic, Cadmium, Chromium under TCLP and landfill leaching conditions. Prior methods using Portland cement produce a reduced permeability matrix or material with strength, whereas the present invention use of Cement Kiln Dust (CKD) acts only to reduce metals solubility and is not applied with the intent or results of significant reducing permeability or significant increasing material of waste strength. Prior art methods of As control with iron and lime combination failed to meet low level SPLP and MEP leaching requirements whereas the use of CKD in combination with insoluble phosphates and iron source provides both improved As and Pb solubility reduction. Prior teachings of the use of water soluble phosphates for Pb control cause As to increase leaching, and thus fail to meet low As TCLP, SPLP and MEP leaching standards. Prior art relating to insoluble phosphates for Pb stabilization fail to recognize the importance of using insoluble phosphates in the presence of As to avoid As leach increases under SPLP, TCLP and MEP.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial waste water contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

Unlike the present invention, however, none of the prior art solutions were designed to allow specifically for stabilization of heavy metal bearing material or waste containing more than one specific heavy metal and also providing a one-step means for achieving SPLP, TCLP and MEP leachability reduction of combinations of Pb and As in the waste or material matrix. The present invention also assures through the use of high water ratios and lack of aggregate that the material and wastes stabilized fail to form a cementious like material and thus are suitable for use and or disposal without having a cement-like permeability reduction or object strength.

### SUMMARY OF THE INVENTION

The present invention discloses a combined Pb and As heavy metal bearing material, contaminated soils, or waste stabilization method under TCLP, SPLP and MEP analyses through contact of material, contaminated soils or waste with a one-step blend of stabilizing agents including water insoluble phosphate, cement kiln dust, and iron source, which are properly chosen to complement the material, contaminated soils or waste constituency and desired material or waste handling characteristics. The stabilizing agents proven effective are provided in both in dry and slurry form, and can be contacted with heavy metal bearing material, contaminated soils or wastes either prior to production such as in-stream at wastewater facilities producing sludge or in-duct prior to air pollution control and ash collection devices or after waste production in material collection devices, in-situ, or in-waste piles.

It is anticipated that the Pb and As stabilizers can be used for both RCRA compliance actions such that generated wastes, contaminated soils or materials from wastewater facilities, furnaces, incinerators and other facilities do not exceed the TCLP hazardous waste criteria under TCLP, or groundwater project limitations for SPLP and MEP under CERCLA (Superfund) response where stabilizers are added to waste piles or storage vessels previously generated. The preferred method of application of stabilizers would be in-line or in-situ within the property and facility generating the heavy metal bearing material, and thus allowed under RCRA as a in-situ, totally enclosed, in-tank or exempt method of TCLP stabilization without the need for a RCRA Part B hazardous waste treatment and storage facility permit.

### DETAILED DESCRIPTION

Environmental regulations throughout the world such as those promulgated by the USEPA under RCRA and CERCLA require heavy metal bearing waste, contaminated soils and material producers to manage such in a manner safe to the environment and protective of human health. In response to these regulations, environmental engineers and scientists have developed numerous means to control heavy metals, mostly through chemical applications which convert the solubility of the material and waste character to a low solubility state and thus low exposure form, thus passing leach tests and allowing the wastes to be either reused on-site or disposed at local landfills without further and more expensive control means such as hazardous waste disposal landfills or facilities designed to provide metals stabilization. The primary focus of scientists has been on singular heavy metals such as lead, cadmium, chromium, arsenic and mercury, as these were and continue to be the most significant mass of metals contamination in soils. Materials such as paints, and cleanup site wastes such as battery acids and slag wastes from smelters are major lead sources. Recently, however, there exists a demand for control methods of heavy metals in combined form as Pb and As in contaminated soils and capable of meeting a combination of test evaluations including TCLP, SPLP and MEP.

The present invention discloses a combined Pb and As bearing material, contaminated soil or waste, stabilization method through contact of material, contaminated soil or waste with stabilizing agents including a single step application combination of water insoluble phosphates, cement kiln dust, and ferric source. The stabilizing agents found effective are available in dry or slurry form, and thus can be contacted with heavy metal bearing material prior to waste generation such as in-stream at wastewater sludge producing plants or in-duct prior to air pollution control and ash collection devices or after waste production in collection devices such as hoppers, dump valves, conveyors, dumpsters, in-situ, in-ground, or in waste piles. The stabilizers are applied in a manner to utilize cement kiln dust as a stabilizing agent and not a cement-like additive thus allowing stabilized material, contaminated soils and waste to remain suitable for fill material or relatively loose handling. The insoluble phosphate agent acts to exchange calcium ions for Pb ions in solution an form Pb substituted calcium phosphate apatite minerals, while not interfering with Ferric Oxide complexing with available As in solution to form insoluble ferric arsenate.

It is anticipated that the stabilizers can be used for both RCRA compliance actions such that generated materials from wastewater facilities, furnaces, incinerators and other facilities do not exceed appropriate SPLP and MEP groundwater criteria and/or TCLP hazardous waste criteria under TCLP or CERCLA (Superfund) response where stabilizers are added to waste piles or storage vessels previously generated and now regulated under RCRA as a hazardous waste pre-disposal. The preferred method of application of stabilizers would be in-situ, in-line within the property and facility generating the heavy metal bearing material, and thus allowed under RCRA as a totally enclosed, in-tank or exempt method of TCLP stabilization without the need for a RCRA Part B hazardous waste treatment and storage facility permit(s).

The use of water insoluble phosphates could include but not be limited to dicalcium phosphate, tricalcium phosphate, monocalcium phosphate, phosphate rock, pulverized forms of all above, and combinations thereof which would, as an example, provide various amount of water insoluble phosphate in combination with cement kiln dust and ferric source with Pb and As bearing material or waste. The water insoluble phosphate, cement kiln dust, ferric source and combination type, size, dose rate, contact duration, and application means could be engineered for each type of heavy metal bearing material, contaminated soils or waste.

Although the exact stabilization formation molecule(s) are unknown at this time, it is expected that when Pb and As come into contact with the stabilizing agent(s), low water and low acid soluble compound(s) begin to form such as a mineral phosphate, twinned mineral or precipitate through substitution or surface bonding, which is less soluble than the heavy metal element or molecule originally in the material or waste. Specifically complexing and/or twinning of Pb and As into pyromorphite amorphous crystals most likely occurs by adding calcium phosphate(s) to the material or waste at standard temperature and pressure. It also remains possible that modifications to temperature and pressure may accelerate of assist formation of minerals, although such methods are not considered optimal for this application given the need to limit cost and provide for optional field based stabilizing operations that would be complicated by the need for pressure and temperature control devices and vessels. Ferric arsenate is likely formed in solution and as a substituted surface reaction and possibly twinned into the calcium phosphate apatite mineral. The kinetics of soluble phosphate causing or contributing to As leaching is not known, but it has been observed that allowing ferric arsenate to form in the presence of water insoluble phosphates achieves a lower soluble As level from the stabilized matrix.

Examples of suitable stabilizing agents include Cement kiln dust, ferric powder, ferric sulfate, ferrous sulfate, ferric chloride, ferrous chloride, water insoluble phosphate fertilizers, phosphate rock, pulverized phosphate rock, calcium orthophosphates, monocalcium phosphate, dicalcium phosphate, tricalcium phosphate, fishbone phosphate, animal bone phosphate, herring meal, bone meal, phosphorites, and combinations thereof. The amounts of stabilizing agent used, according to the method of invention, depend on various factors including desired TCLP, SPLP, and MEP solubility reduction potential, desired mineral toxicity, and desired mineral formation relating to toxicological and site environmental control objectives. It has been found that an amount of certain stabilizing agents such as 8% Cement Kiln Dust, 0.5% Ferric powder, and 1.0% Dicalcium Phosphate by weight of Pb and As bearing contaminated soil both unsaturated and brackish groundwater saturated was sufficient for TCLP, SPLP, and MEP stabilization to less than limits of 10 parts per billion (ppb) Pb and 200 ppb As. However, the foregoing is not intended to preclude yet higher or lower usage of stabilizing agent or combinations if needed since it has been demonstrated that amounts greater than 10% CKD and 1% phosphate by weight also work, but are more costly.

The examples below are merely illustrative of this invention and are not intended to limit it thereby in any way.

### EXAMPLE 1

In this example Pb and As contaminated soil (waste from Conoco Phillips operations) collected by URS personnel at soil remediation project in Weymouth, Mass., was stabilized with varying amounts of stabilizing agents including Magnesium Oxide (MgO), Cement Kiln Dust (CKD), ferric oxide powder (FP), DiCalcium Phosphate (DCP), Triple Superphosphate (TSP) and combinations thereof. Various stabilized and un-stabilized soil samples were subsequently tested for SPLP, TCLP, and MEP#10 soluble Pb and As and compared to project limitations for TCLP Pb and As of 5 ppm, and SPLP and MEP of 10 ppb Pb and 200 ppb As. Soil samples were extracted according to SPLP, TCLP, and MEP procedure set forth by the USEPA Method 1312, 1311 and 1320 respectively. The extract samples were digested and then analyzed by ICP USEPA Method 200.7.

TABLE 1

| | | | MEP Pb/As |
|---|---|---|---|
| Stabilizer Dose (%) | SPLP Pb/As | TCLP Pb/As | (ppm) |
| 0 (Baseline) | 14/27 | 15/31 | 11/20 |
| 8 CKD + 0.5 FP + 1.0 DCP | <0.05/<0.05 | <0.05/<0.05 | <0.05/<0.05 |
| 8 CKD + 0.5 FP + 1.0 TSP | <0.05/13.1 | <0.05/23 | <0.05/2.4 |
| 8 MgO + 0.5 FP + 1.0 DCP | <0.05/0.30 | 0.1/0.15 | 0.30/1.60 |

The foregoing results in Table 1 readily established the operability of the present process to stabilize combined Pb and As thus reducing SPLP, TCLP and MEP leachability and bioavailability. Given the effectiveness of the stabilizing agents in causing combined heavy metals to stabilize as presented in the Table 1, it is believed that an amount of the stabilizing agents total combined equivalent weight to less than 7% of heavy metal bearing material or waste should be effective. It is also apparent from the Table 1 results that certain stabilizing agent combinations are more effective for stabilization of Pb and As than individual stabilizing agent methods.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of lead (Pb) and arsenic (As) bearing material, waste or contaminated soil, comprising contacting material, contaminated soil or waste with at a combination of cement kiln dust, iron oxide and insoluble phosphate stabilizing agent in an amount effective in reducing the leaching of Pb and As from the material or waste to a level no more than RCRA and CERCLA acceptable levels as determined under extraction methods SPLP, TCLP and MEP as set forth in USEPA Methods 1312, 1311 and 1320.

2. The method of claim 1, wherein the stabilizing agents are selected from the groups consisting of the first agent cement kiln dust, the second agent water insoluble phosphate source selected from phosphate rock, bone phosphate, fishbone phosphates, dicalcium phosphate, tricalcium phosphate, and the third agent ferric source selected from ferric powder, ferric sulfate, ferric chloride, ferrous chloride, ferrous sulfate, and combinations thereof.
